(19) United States
(12) Patent Application Publication
(10) Pub. No.: US 2024/0022850 A1
(43) Pub. Date: Jan. 18, 2024

(54) HYBRID LOUDSPEAKER AND AUDIO REPRODUCTION DEVICE

(71) Applicant: GUANGDONG OPPO MOBILE TELECOMMUNICATIONS CORP., LTD., Dongguan (CN)

(72) Inventor: Ze WANG, Dongguan (CN)

(21) Appl. No.: 18/447,018

(22) Filed: Aug. 9, 2023

Related U.S. Application Data
(63) Continuation of application No. PCT/CN2022/073830, filed on Jan. 25, 2022.

(30) Foreign Application Priority Data
Feb. 10, 2021 (CN) 202110187132.X
Feb. 10, 2021 (CN) 202120374472.9

(51) Int. Cl. H04R 1/24; H04R 1/10; H04R 9/02; H04R 9/04; H04R 7/04; H04R 7/12; H04R 9/06

(52) U.S. Cl. CPC H04R 1/24; H04R 1/1075; H04R 9/025; H04R 9/046; H04R 7/04; H04R 7/12; H04R 9/06; H04R 2400/11; H04R 1/1041; H04R 1/1016

(57) ABSTRACT

Provided is a hybrid speaker. The hybrid speaker includes a low-frequency portion and a high-frequency portion. The low-frequency portion is configured to output mid-frequency sound or low-frequency sound. The low-frequency portion includes a moving-coil unit-structure, and the moving-coil unit-structure includes a magnetic driving portion. the high-frequency portion is configured to output high-frequency sound, and the high-frequency portion includes a balanced- diaphragm unit-structure; and the balanced-diaphragm unit-structure is configured as the magnetic driving portion of the moving-coil unit-structure. A sound reproduction device having a loudspeaker is also provided.

### CROSS-REFERENCE TO RELATED APPLICATION(S)

This application is a continuation of International Application No. PCT/CN2022/073830, filed Jan. 25, 2022, which claims priority to Chinese Patent Application No. 202110187132.X, filed Feb. 10, 2021, and priority to Chinese Patent Application No. 202120374472.9, filed Feb. 10, 2021. The entire disclosures of the aforementioned applications are incorporated herein by reference.

### TECHNICAL FIELD

This disclosure relates to the field of electronic devices, and in particular, to a hybrid speaker and an audio reproduction device having the same.

### BACKGROUND

An existing loudspeaker generally uses a moving-coil unit. Although the moving-coil unit has an excellent and powerful low-frequency, the moving-coil unit is not accurate enough for high-frequency detail and high-frequency definition, lacks an ultra-frequency response, and a diaphragm is unable to respond quickly to a voice coil. Transient and attenuation characteristics are not good, which manifests in a frequency response curve as a lack of ultra-high frequency response.

### SUMMARY

The present disclosure provides a hybrid speaker and an audio reproduction device having the hybrid speaker.

The present disclosure provides a hybrid speaker. The hybrid speaker includes a low-frequency portion and a high-frequency portion. The low-frequency portion is configured to output mid-frequency sound or low-frequency sound. The low-frequency portion includes a moving-coil unit-structure, and the moving-coil unit-structure includes a magnetic driving portion. The high-frequency portion is configured to output high-frequency sound, and the high-frequency portion includes a balanced-diaphragm unit-structure. The balanced-diaphragm unit-structure is configured as the magnetic driving portion of the moving-coil unit-structure.

The present disclosure also provides an audio reproduction device. The audio reproduction device includes a housing and a hybrid speaker. The hybrid speaker includes a low-frequency portion and a high-frequency portion. The low-frequency portion is configured to output mid-frequency sound or low-frequency sound. The low-frequency portion includes a moving-coil unit-structure, and the moving-coil unit-structure includes a magnetic driving portion. The high-frequency portion is configured to output high-frequency sound, and the high-frequency portion includes a balanced-diaphragm unit-structure. The balanced-diaphragm unit-structure is configured as the magnetic driving portion of the moving-coil unit-structure. The housing defines an inner cavity and a sound channel communicating with the inner cavity, the hybrid speaker is disposed in the inner cavity, and a first sound hole and a second sound hole of the hybrid speaker communicate with the sound channel.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

In order to describe technical solutions in implementations of the disclosure more clearly, the following will give a brief introduction to the accompanying drawings required for describing implementations. Apparently, the accompanying drawings hereinafter described are merely some implementations of the disclosure. Based on these drawings, those of ordinary skill in the art can also obtain other drawings without creative effort.

FIG. 1 is a perspective schematic structural view of a hybrid speaker according to an implementation of the present disclosure.

FIG. 2 is a sectional view taken along line II-II in FIG. 1.

FIG. 3 is a perspective exploded schematic structural view of the hybrid speaker in FIG. 1.

FIG. 4 is a perspective schematic structural view of a shell in FIG. 3.

FIG. 5 is a perspective schematic structural view of the shell in FIG. 4 from another perspective.

FIG. 6 is an enlarged perspective schematic structure view of a balanced-diaphragm unit-structure and a first shell in FIG. 3.

FIG. 7 is a schematic partial sectional assembly view of the balanced-diaphragm unit-structure and the first shell in FIG. 6.

FIG. 8 is a perspective schematic structural view of a circuit board assembly in FIG. 3.

FIG. 9 is a perspective schematic structural view of an audio reproduction device according to one implementation of the present disclosure.

### DETAILED DESCRIPTION

A hybrid speaker includes a low-frequency portion and a high-frequency portion. The low-frequency portion is configured to output mid-frequency sound or low-frequency sound, where the low-frequency portion includes a moving-coil unit-structure, and the moving-coil unit-structure includes a magnetic driving portion. The high-frequency portion is configured to output high-frequency sound, where the high-frequency portion includes a balanced-diaphragm unit-structure, and the balanced-film unit-structure is configured as the magnetic driving portion of the moving-coil unit-structure.

The balanced-diaphragm unit-structure includes a first shell, and the first shell is cylindrical; and the moving-coil unit-structure includes a voice coil, and the voice coil is partially sleeved outside the first shell.

The balanced-diaphragm unit-structure further includes a first coil, a second coil, and a first diaphragm that are disposed in an inner cavity of the first shell, the first coil is coaxial with the second coil, a first gap is defined between the first coil and the second coil, and the first diaphragm is disposed in the first gap.

The balanced-diaphragm unit-structure further includes a first magnet sleeved outside the first coil and a second magnet sleeved outside the second coil, and the first gap is defined between the first magnet and the second magnet.

The balanced-diaphragm unit-structure further includes a first washer and a second washer that are disposed in the first gap, the first washer is disposed between the first diaphragm and the first magnet, and the second washer is disposed between the first diaphragm and the second magnet, and the first washer and the second washer are configured to limit the first diaphragm.

The first shell includes a connecting cylinder sleeved outside the first magnet and the second magnet, and a magnetic conductive plate connected to one end of the connecting cylinder away from the first magnet, the second magnet is stacked on the magnetic conductive plate, the magnetic conductive plate is configured to adjust a magnetic field of the balanced-diaphragm unit-structure, so as to realize a function of the magnetic driving portion in the moving-coil unit-structure.

The hybrid speaker further includes a second shell, where the second shell is configured as an outer frame of the moving-coil unit-structure, the first shell is connected to an inner wall of the second shell, the moving-coil unit-structure further includes a second diaphragm connected to the voice coil, and one end of the voice coil away from the second diaphragm is sleeved around the magnetic conductive plate.

The second shell defines a first sound hole, the first sound hole communicates a first inner cavity of the second shell with an external space, and the first sound hole is configured as a sound channel of the low-frequency portion.

The second shell defines a second sound hole, the second sound hole communicates a second inner cavity of the first shell with the external space, and the second sound hole is configured as a sound channel of the high-frequency portion.

A periphery of the second diaphragm is connected to an opening of the second shell, and the second diaphragm, the first shell, and the second shell cooperative define the first inner cavity.

The second shell includes a top wall and a side wall surrounding a periphery of the top wall, one end of the connecting cylinder away from the magnetic conductive plate is connected to the top wall, the first sound hole is defined in the side wall, and the second sound hole is defined in the top wall.

The side wall includes a first cylinder surrounding a periphery of the top wall and a second cylinder disposed at one end of the first cylinder away from the top wall, and a connecting plate connected between the first cylinder and the second cylinder; and where a periphery of the second diaphragm is connected to an inner circumferential wall of the second cylinder, and the first sound hole is defined in the connecting plate.

An inner diameter of the second cylinder is greater than an inner diameter of the first cylinder.

The connecting cylinder is coaxial with the first cylinder, an outer diameter of the connecting cylinder is less than an inner diameter of the first cylinder, a second gap is defined between the connecting cylinder and the first cylinder, and the voice coil is disposed in the second gap.

The hybrid speaker further includes a rear cover, where the rear cover fits with the side wall, and the rear cover defines a sound-adjusting hole.

The hybrid speaker further includes a first circuit board, where the first circuit board is disposed on an outer side of the top wall, and the first coil and the second coil are electrically connected to the first circuit board respectively.

The first circuit board is positioned on the outer side of the top wall, the top wall defines a wire groove on an inner side of the top wall, the first coil and the second coil are connected to the first circuit board through wires, and the wires are accommodated in the wire groove.

The hybrid speaker further includes a second circuit board, where the second circuit board is disposed on an outer side of the side wall, and the voice coil is electrically connected to the second circuit board.

The second shell defines a wire outlet at a position of the side wall of the second shell away from the top wall, and the wire outlet is configured for insertion of a wire.

An audio reproduction device includes a housing and a hybrid speaker, where the housing defines an inner cavity and a sound channel communicating with the inner cavity, the hybrid speaker is disposed in the inner cavity, and a first sound hole and a second sound hole of the hybrid speaker communicate with the sound channel.

The following will illustrate technical solutions of implementations of the disclosure with reference to the accompanying drawings of implementations of the disclosure. Apparently, implementations described herein are merely some implementations, rather than all implementations, of the disclosure. Based on the implementations of the disclosure, all other implementations obtained by those of ordinary skill in the art without creative effort shall fall within the protection scope of the disclosure.

In addition, the following description of implementations are provided with reference to accompanying drawings to illustrate specific implementations that can be implemented in the present disclosure. Directional terms mentioned in the present disclosure, such as “up”, “low”, “front”, “rear”, “left”, “right”, “inner”, “outer”, “side”, etc. , are only directions with reference to accompanying drawings, and therefore the directional terms used herein are for better and clearer illustration and understanding of the present disclosure, rather than explicitly or implicitly indicate that apparatuses or components referred to herein must have a certain direction or be configured or operated in a certain direction and therefore cannot be understood as limitation on the disclosure.

Unless stated otherwise, in the disclosure, terms “installing”, “coupling”, “connecting”, “disposed on”, and the like referred to herein should be understood in broader sense. For example, connecting may be a fixed connecting, a removable connecting, or an integrated connecting, may be a mechanical connecting, and may be a direct connecting, an indirect connecting through a medium, or a communication connecting between two components. For those of ordinary skill in the art, the above terms in the present disclosure can be understood according to specific situations.

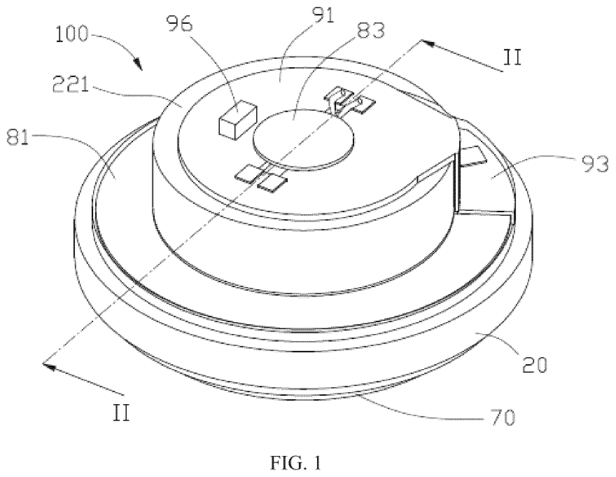

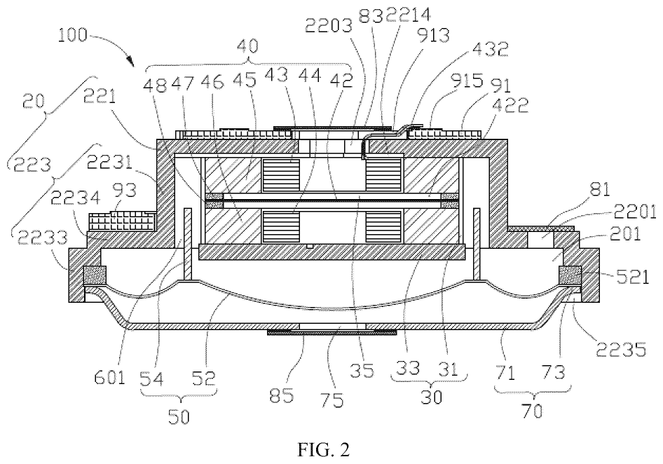

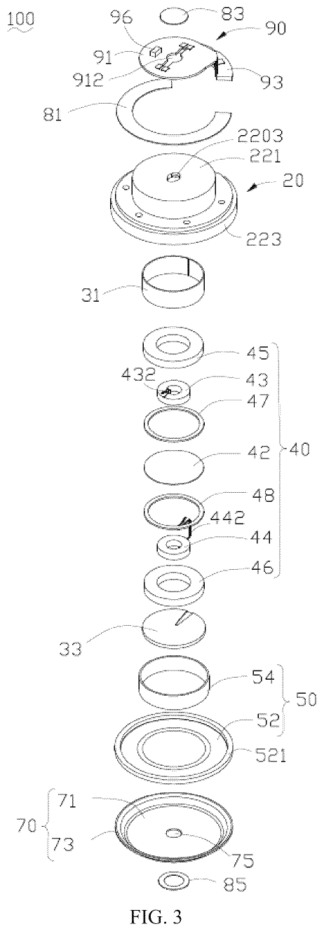

Please refer to FIGS. 1 to 3 together, where FIG. 1 is a perspective schematic structural view of a hybrid speaker 100 according to an implementation of the present disclosure, FIG. 2 is a sectional view taken along line II-II in FIG. 1, and FIG. 3 is a perspective exploded schematic structural view of the hybrid speaker 100 in FIG. 1. The hybrid speaker 100 in one implementation of the present disclosure includes a high-frequency portion and a low-frequency portion. The high-frequency portion is configured to output high-frequency sound, the high-frequency portion includes a balanced-diaphragm unit-structure 40, the balanced-diaphragm unit-structure 40 includes a first diaphragm 42, and the first diaphragm 42 vibrates to output the high-frequency sound. The low-frequency portion is configured to output mid-frequency sound and/or low-frequency sound, the low-frequency portion includes a moving-coil unit-structure 50, and the moving-coil unit-structure 50 includes a second diaphragm 52 and a magnetic driving portion. The balanced-diaphragm unit-structure 40 is configured as the magnetic driving portion of the moving-coil unit-structure 50, and the magnetic driving portion drives the second diaphragm 52 to vibrate to output the mid-frequency sound and/or the low-frequency sound. Therefore, a magnetic driving portion of the balanced-diaphragm unit-structure 40 is used for the balanced-diaphragm unit-structure 40, and is also configured as the magnetic driving portion of the moving-coil unit-structure 50, that is, the balanced-diaphragm unit-structure 40 and the moving-coil unit-structure 50 share the magnetic driving portion.

The hybrid speaker 100 provided in the present disclosure includes the balanced-diaphragm unit-structure 40 and the moving-coil unit-structure 50. The balanced-diaphragm unit-structure 40 is configured as the magnetic driving portion of the moving-coil unit-structure 50, that is, the balanced-diaphragm unit-structure 40 and the moving-coil unit-structure 50 share the magnetic driving portion. Therefore, firstly, the moving-coil unit-structure 50 enables the hybrid speaker 100 to have excellent and powerful mid-low frequency sound, and the balanced-diaphragm unit-structure 40 enables the hybrid speaker 100 to have smooth high-frequency sound; secondly, the balanced-diaphragm unit-structure 40 and the moving-coil unit-structure 50 share the magnetic driving portion, which not only greatly reduces manufacturing costs of the hybrid speaker 100, but also reduces an internal space of the hybrid speaker 100 occupied by the magnetic driving portion, and can further reduce the volume of the hybrid speaker 100 to comply with a miniaturization trend of products.

As illustrated in FIG. 2, the hybrid speaker 100 further includes a first shell 30 and a second shell 20, the first shell 30 is disposed in an inner cavity of the second shell 20, both the balanced-diaphragm unit-structure 40 and the moving-coil unit-structure 50 are disposed in the inner cavity of the second shell 20, and the second shell 20 is configured as an outer frame of the moving-coil unit-structure 50. In an implementation, the balanced-diaphragm unit-structure 40 and the moving-coil unit-structure 50 are disposed in the inner cavity of the first shell 30 in an axial direction of second shell 20. In this implementation, the first shell 30 is cylindrical, the moving-coil unit-structure 50 further includes a voice coil 54 connected to the second diaphragm 52, and the voice coil 54 is partially sleeved outside the first shell 30. Since the balanced-diaphragm unit-structure 40 is disposed in the inner cavity of the first shell 30, and at least a part of the voice coil 54 is axially sleeved outside the first shell 30, the magnetic driving portion of the balanced-diaphragm unit-structure 40 forms a magnetic field around the first shell 30, and the magnetic field is the magnetic driving portion of the moving-coil unit-structure 50. When the voice coil 54 is electrified, the magnetic driving portion can drive the voice coil 54 to vibrate in the axial direction of second shell 20.

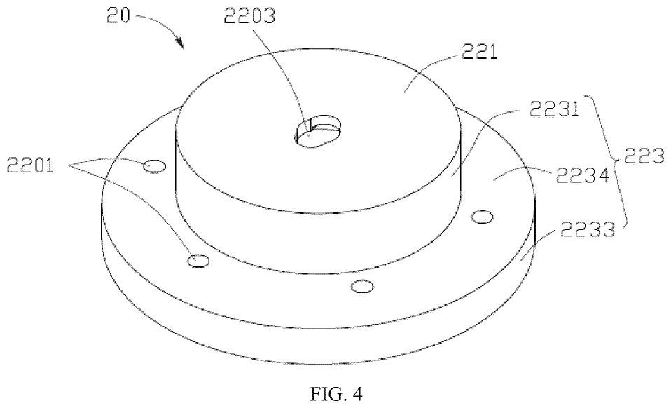

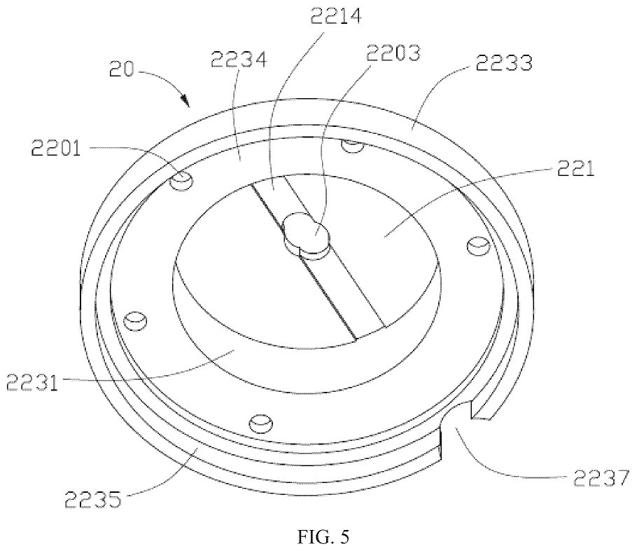

Please refer to FIGS. 2 to 5 together, where FIG. 4 is a perspective schematic structural view of the second shell 20 in FIG. 3 and FIG. 5 is a perspective schematic structural view of the second shell 20 in FIG. 4 from another perspective. The second shell 20 includes a top wall 221 and a side wall 223 surrounding a periphery of the top wall 221. The first shell 30 is connected to an inner side of the top wall 221. A periphery of the second diaphragm 52 is connected to an inner circumferential wall of the second shell 20 close to an opening of the second shell 20. The moving-coil unit-structure 50 is farther away from the top wall 221 than the balanced-diaphragm unit- structure 40. In this case, the second diaphragm 52, the first shell 30, and the second shell 20 cooperatively define a first inner cavity 201. The second shell 20 defines at least one first sound hole 2201 and at least one second sound hole 2203. The first sound hole 2201 communicates the first inner cavity 201 of the second shell 20 to an external space, and the first sound hole 2201 is configured as a sound channel of the low-frequency portion. The first shell 30 defines a second inner cavity 35, the second sound hole 2203 communicates the second inner cavity 35 of the first shell 30 with the external space, and the second sound hole 2203 is configured as a sound channel of the high-frequency portion. Specifically, the second sound hole 2203 is defined in the second shell 20, and the second sound hole 2203 is in a region of an orthographic projection of the first shell 30 on the second shell 20.

In this implementation, the first sound hole 2201 is defined in the side wall 223, and the second sound hole 2203 is defined in the top wall 221. In an implementation, the second sound hole 2203 is defined in the middle of the top wall 221, and the periphery of the second diaphragm 52 is connected to an inner circumferential wall of the side wall 223 at one end of the side wall 223 away from the top wall 221. The second sound hole 2203 corresponds to the first diaphragm 42, and sound generated by vibration of the first diaphragm 42 is output from the second sound hole 2203 through the second inner cavity 35. The first sound hole 2201 corresponds to the second diaphragm 52, and sound generated by vibration of the second diaphragm 52 is output from the first sound hole 2201 through the first inner cavity 201.

In this implementation, the top wall 221 is a circular plate, and the side wall 223 is a cylinder surrounding an edge of the circular plate. In other implementations, the top wall 221 may be, but is not limited to, an elliptic plate, a polygonal plate, or a waist-shaped plate, and the side wall 223 surrounds an edge of the top wall 221.

As illustrated in FIGS. 2, 4, and 5, the side wall 223 includes a first cylinder 2231 surrounding an edge of the top wall 221, and a second cylinder 2233 below the first cylinder 2231, and a connecting plate 2234 connected between the first cylinder 2231 and the second cylinder 2233. An inner diameter of the second cylinder 2233 is greater than that of the first cylinder 2231, the periphery of the second diaphragm 52 is connected to an inner circumferential wall of the second cylinder 2233, and the first sound hole 2201 is defined in the connecting plate 2234. In this implementation, both the first cylinder 2231 and the second cylinder 2233 are cylinders, the first cylinder 2231 and the second cylinder 2233 are coaxial, the connecting plate 2234 is an annular plate parallel to the top wall 221, and multiple first sound holes 2201 are defined in an outer side of the connecting plate 2234 in a circumferential direction of the connecting plate 2234. In an implementation, the multiple first sound holes 2201 are arranged at equal intervals. The second cylinder 2233 defines a positioning groove 2235 at a lower end of the inner circumferential wall of the second cylinder 2233, the positioning groove 2235 is defined in a circumferential direction of the second cylinder 2233, and the periphery of the second diaphragm 52 is connected to the positioning groove 2235. In an implementation, the periphery of the second diaphragm 52 is positioned in the positioning groove 2235 via a connecting pad 521.

In an implementation, an inner surface of the top wall 221 defines a wire groove 2214 communicating with the second sound hole 2203, and the wire groove 2214 is configured to accommodate a wire. In this implementation, the wire groove 2214 extends in a radial direction of the top wall 221 and communicates with the second sound hole 2203.

In an implementation, the side wall 223 defines a wire outlet 2237 at a position of the side wall 223 away from the top wall 221, and the wire outlet 2237 is configured for insertion of a wire.

As illustrated in FIG. 2, the balanced-diaphragm unit-structure 40 includes a first coil 43 and a second coil 44 that are disposed in the second inner cavity 35 of the first shell 30, the first coil 43 is coaxial with the second coil 44, and the first coil 43 and the second coil 44 are disposed at two opposite sides of the first diaphragm 42. A first gap 422 is defined between the first coil 43 and the second coil 44, and the first diaphragm 42 is disposed in the first gap 422. In this implementation, the first diaphragm 42 is a circular superconducting magnetic miniature amorphous ultrathin alloy flat film, the first coil 43, the second coil 44, and the first diaphragm 42 are coaxial, and the first coil 43 and the second coil 44 are electrified to drive the first diaphragm 42 to vibrate, so as to generate sound.

Further, the balanced-diaphragm unit-structure 40 further includes a first magnet 45 sleeved outside the first coil 43 and a second magnet 46 sleeved outside the second coil 44, the first magnet 45 and the second magnet 46 are accommodated in the second inner cavity 35 of the first shell 30, and the first gap 422 is defined between the first magnet 45 and the second magnet 46. In this implementation, both the first magnet 45 and the second magnet 46 are magnet rings, and the first coil 43, the first magnet 45, the second coil 44, the second magnet 46, and the first diaphragm 42 are coaxial. A magnetic field is formed around the first magnet 45 and the second magnet 46, one end of the voice coil 54 away from the second diaphragm 52 is movably sleeved around a magnetic conductive plate 33, and when the voice coil 54 is electrified, the voice coil 54 vibrates axially in the magnetic field formed by the first magnet 45 and the second magnet to drive the second diaphragm 52 to vibrate, so as to generate sound. An outer side refers to a side facing the same direction as a sound-emitting direction of the hybrid speaker 100, and an inner side refers to a side facing an opposite direction to the sound-emitting direction of the hybrid speaker 100.

The first diaphragm 42 is disposed between the first magnet 45 and the second magnet 46, the first coil 43 is sleeved in an inner cavity of the first magnet 45, and the second coil 44 is sleeved in an inner cavity of the second magnet 46, so as to cooperate to form the high-frequency portion. One end of the voice coil 54 is connected to the second diaphragm 52, and one end of the voice coil 54 away from the second diaphragm 52 is movably sleeved around the first shell 30, so as to cooperate to form the low-frequency portion. Therefore, the high-frequency portion and the low-frequency portion share a magnetic driving portion, that is, the first magnet 45 and the second magnet 46 not only cooperate with the first coil 43 and the second coil 44 of the balanced-diaphragm unit-structure 40, but also cooperate with the voice coil 54 of the moving-coil unit-structure 50. The balanced-diaphragm unit-structure 40 and the moving-coil unit-structure 50 share the magnetic driving portion, so that the manufacturing costs of the hybrid speaker 100 are reduced, and an internal space of the second shell 20 occupied by the magnetic driving portion is reduced, thereby complying with the miniaturization trend of products. When the first coil 43 and the second coil 44 are electrified, the first diaphragm 42 is magnetized, so that the first diaphragm 42 is subject to a force between the first magnet 45 and the second magnet 46 to enable the first diaphragm 42 to vibrate axially up and down, and the force directly acts on the first diaphragm 42, so that there is no transmission loss and no transmission delay, resulting in better high-frequency transient and extension. In addition, the force is evenly distributed throughout the first diaphragm 42, and thud the hybrid speaker 100 has an innate advantage in dynamic and sound information volume.

In an implementation, the first diaphragm 42 is made of a flexible high polymer material, thereby enabling the hybrid speaker 100 to have smooth high-frequency sound. The periphery of the second diaphragm 52 is connected to the inner circumferential wall of the second shell 20. One end of the voice coil 54 is connected to the second diaphragm 52, the other end of the voice coil 54 is movably sleeved around the first magnet 45 and the second magnet 46, and the voice coil 54 is a coil wound by an insulated wire. When a variable audio signal is input into the voice coil 54, the voice coil 54 is magnetized, and the magnetic field of the first magnet 45 and the second magnet 46 enables the voice coil 54 to be forced to drive the second diaphragm 52 to vibrate to generate sound. As such, the moving-coil unit-structure 50 has an excellent and powerful low-frequency. The hybrid speaker 100 of the present disclosure not only has an excellent and powerful low-frequency, but also has a smooth high-frequency.

Optionally, the second diaphragm 52 is made of a lightweight and flexible high polymer material. The second diaphragm 52 may be a single-layer composite or a multi-layer composite. The second diaphragm 52 may be integrally formed or independently formed in structure.

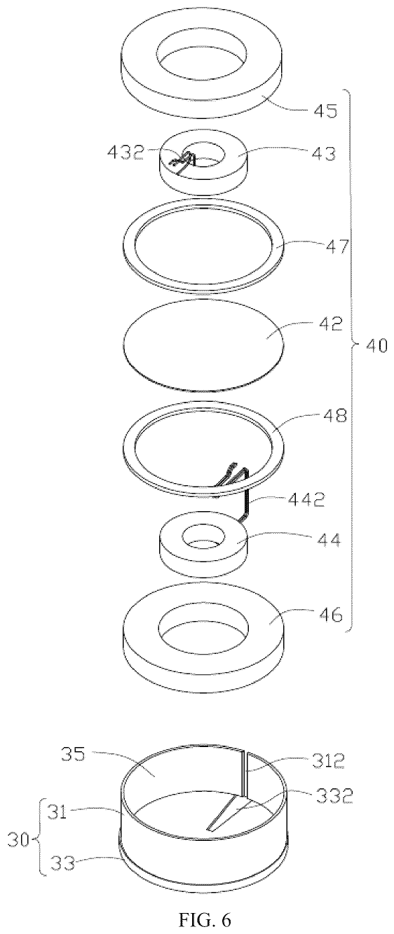

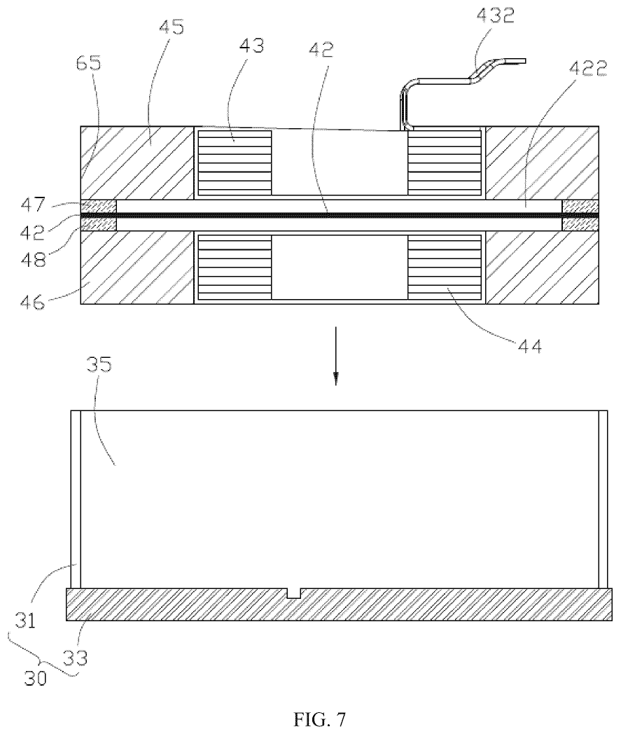

Please refer to FIGS. 2, 3, 6, and 7 together, where FIG. 6 is an enlarged perspective schematic structure view of the balanced-diaphragm unit-structure 40 and the first shell 30 in FIG. 3, and FIG. 7 is a schematic partial sectional assembly view of the balanced-diaphragm unit-structure 40 and the first shell 30 in FIG. 6. The balanced-diaphragm unit-structure 40 is accommodated in the first shell 30, and the first shell 30 is configured to position the balanced-diaphragm unit-structure 40 on the top wall 221. A second gap 601 is defined between the first shell 30 and the side wall 223, and the voice coil 54 is disposed in the second gap 601, that is, one end of the voice coil 54 away from the second diaphragm 52 can be movably inserted into the second gap 601. Specifically, the first shell 30 includes a connecting cylinder 31 sleeved outside the first magnet 45 and the second magnet 46, and the magnetic conductive plate 33 connected to one end of the connecting cylinder 31 away from the first magnet 45. The second magnet 46 is stacked on the magnetic conductive plate 33. The magnetic conductive plate 33 is configured to adjust a magnetic field of the balanced-diaphragm unit-structure 40, so as to implement a function of the magnetic driving portion in the moving-coil unit-structure 50. Specifically, the magnetic conductive plate 33 is made of a magnetic conductive material such as an iron plate, and the magnetic conductive plate 33 is configured to adjust the magnetic field of the second magnet 46 and the first magnet 45, so that most of magnetic field lines of the second magnet 46 and the first magnet 45 pass through the magnetic conductive plate 33 to be conducted to surroundings of the voice coil 54, thereby implementing the function of the magnetic driving portion in the moving-coil unit-structure 50.

In this implementation, one end of the connecting cylinder 31 away from the magnetic conductive plate 33 is fixedly connected to the top wall 221 by means of clamping, welding, or the like and the connecting cylinder 31 surrounds the second sound hole 2203. The connecting cylinder 31 and the magnetic conductive plate 33 cooperatively define the second inner cavity 35. The connecting cylinder 31 is coaxial with the first cylinder 2231, an outer diameter of the connecting cylinder 31 is less than an inner diameter of the first cylinder 2231, an outer diameter of the magnetic conductive plate 33 is equal to or slightly greater than the outer diameter of the connecting cylinder 31, and the outer diameter of the magnetic conductive plate 33 is less than the inner diameter of the first cylinder 2231, so that the annular second gap 601 is defined between the connecting cylinder 31 and the first cylinder 2231. Specifically, the connecting cylinder 31 is a metal sheet surrounding the magnetic conductive plate 33, and a wire slot 312 is defined on a circumferential wall of the connecting cylinder 31.

In this implementation, the magnetic conductive plate 33 is a circular iron plate, the connecting cylinder 31 is a cylinder surrounding the circular plate, and the magnetic conductive plate 33 and the connecting cylinder 31 may be fixedly connected with each other by means of clamping or welding. In an implementation, the magnetic conductive plate 33 also defines, in an inner surface of the magnetic conductive plate 33, a wire groove 332 communicating with the wire slot 312.

In this implementation, the outer diameter of the first magnet 45 is equal to the outer diameter of the second magnet 46, the inner diameter of the first magnet 45 is equal to the inner diameter of the second magnet 46, the outer diameter of the first coil 43 is equal to the outer diameter of the second coil 44, and the inner diameter of the first coil 43 is equal to the inner diameter of the second coil 44. The outer diameter of the first coil 43 is equal to the inner diameter of the first magnet 45, so that the first coil 43 can be clamped in the inner cavity of the first magnet 45. The outer diameter of the second coil 44 is equal to the inner diameter of the second magnet 46, so that the second coil 44 can be clamped in the inner cavity of the second magnet 46. The second coil 44 is coaxial with the second magnet 46. The outer diameter of the first magnet 45 and the outer diameter of the second magnet 46 each are equal to or slightly less than the inner diameter of the connecting cylinder 31, so that the first magnet 45 and the second magnet 46 are installed in the inner cavity of the first shell 30. The first coil 43 is electrically connected to a circuit board of the hybrid speaker 100 through a wire 432, and the second coil 44 is electrically connected to the circuit board of the hybrid speaker 100 through a wire 442, so that the first coil 43 and the second coil 44 each can be connected to the circuit board of the hybrid speaker 100.

The balanced-diaphragm unit-structure 40 further includes a first washer 47 and a second washer 48, where the first washer 47 is disposed between a periphery of the first diaphragm 42 and the first magnet 45, and the second washer 48 is disposed between the periphery of the first diaphragm 42 and the second magnet 46. The first washer 47 and the second washer 48 are respectively disposed on two opposite sides of the first diaphragm 42, so as to limit the first diaphragm 42. An outer diameter of the first washer 47 and an outer diameter of the second washer 48 are each equal to or slightly less than the inner diameter of the connecting cylinder 31, an inner diameter of the first washer 47 is far greater than the inner diameter of the first magnet 45 and the inner diameter of the second magnet 46, and an inner diameter of the second washer 48 is far greater than the inner diameter of the first magnet 45 and the inner diameter of the second magnet 46, so that the first diaphragm 42 has enough space at a front side and a rear side of the first diaphragm 42 to facilitate vibration of the first diaphragm 42.

When the balanced-diaphragm unit-structure 40 is assembled to the first shell 30, the first magnet 45 is sleeved outside the first coil 43, the second magnet 46 is sleeved outside the second coil 44. The first washer 47 and the second washer 48 are respectively positioned at edges of two opposite sides of the first diaphragm 42, that is, the first diaphragm 42 is clamped between the first washer 47 and the second washer 48. The second magnet 46, an entirety of the first diaphragm 42, the first washer 47, and the second washer 48, and the first magnet 45 are sequentially disposed into the second inner cavity 35 of the first shell 30, such that the second magnet 46, the second washer 48, the first diaphragm 42, the first washer 47, and the first magnet 45 are stacked in an axial direction, the wire 442 of the second coil 44 extends along the wire groove 332 out of the connecting cylinder 31, and the wire 432 of the first coil 43 extends out of the connecting cylinder 31 through the wire slot 312. In this case, the magnetic conductive plate 33 supports the balanced-diaphragm unit-structure 40, the first diaphragm 42, the first coil 43, and the second coil 44 are coaxial, and the first washer 47 and the second washer 48 are clamped between the first magnet 45 and the second magnet 46, so that the first gap 422 is defined between the first magnet 45 and the second magnet 46. The first washer 47 and the second washer 48 clamp and position the first diaphragm 42, so that the first diaphragm 42 is disposed in the first gap 422.

In other implementations, the connecting cylinder 31 and the magnetic conductive plate 33 may also be integrally formed.

In other implementations, the first washer 47, the second washer 48, and the first diaphragm 42 may also be integrally formed by using different materials.

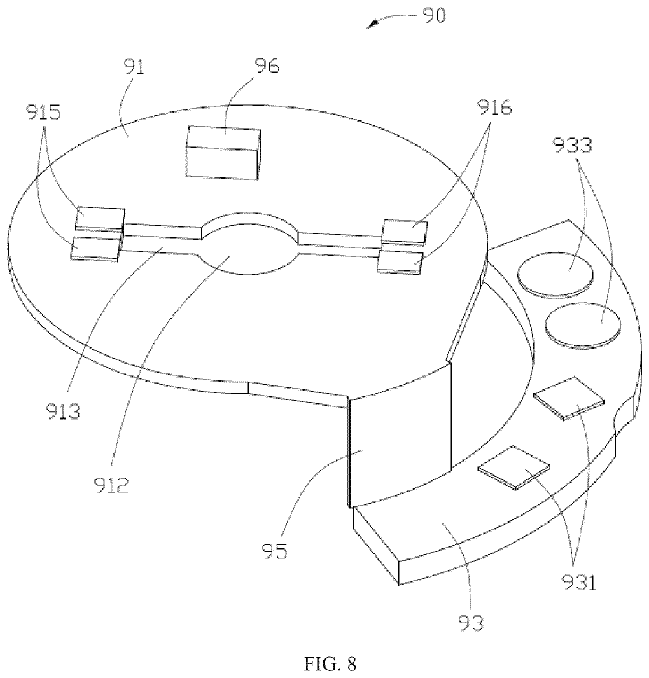

Please refer to FIGS. 2, 3 and 8 together, where FIG. 8 is a perspective schematic structural view of a circuit board assembly 90 in FIG. 3. The hybrid speaker 100 further includes the circuit board assembly 90. The circuit board assembly 90 includes a first circuit board 91 disposed on the top wall 221 and a second circuit board 93 electrically connected to the first circuit board 91. The second circuit board 93 is positioned on the side wall 223. The first circuit board 91 is configured to control output of the high-frequency portion, and the first coil 43 and the second coil 44 are electrically connected to the first circuit board 91 respectively. The second circuit board 93 is configured to control output of the low-frequency portion, and the voice coil 54 is electrically connected to the second circuit board 93. Specifically, the first circuit board 91 is stacked on an outer side of the top wall 221. The first circuit board 91 defines a through hole 912 in the middle of the first circuit board 91 and two wire slots 913 communicating with the through hole 912. The through hole 912 communicates with the second sound hole 2203 in the top wall 221. The wire slots 913 are configured to allow wires 432 and 442 to pass through. The first circuit board 91 is provided with a solder pad adjacent to each wire slot 913, and the pads are configured to be electrically connected to the wire 432 and the wire 442 respectively. In an implementation, a first solder pad 915 is disposed at one end of one wire slot 913 away from the through hole 912, and the first solder pad 915 is configured to be electrically connected to the wire 432. A second solder pad 916 is disposed at one end of the other wire slot 913 away from the through hole 912, and the second solder pad 916 is configured to be electrically connected to the wire 442. In an implementation, the first circuit board 91 is a circular flexible circuit board.

In this implementation, the second circuit board 93 is disposed at an outer side of the connecting plate 2234. Specifically, the second circuit board 93 is an arc-shaped printed circuit board (PCB), the second circuit board 93 is provided with a third solder pad 931, and the third solder pad 931 is configured to be electrically connected to the voice coil 54. The second circuit board 93 is also provided with an external signal port 933, and the external signal port 933 is configured to be electrically connected to an external signal wire. The second circuit board 93 is electrically connected to the first circuit board 91 through a flexible flat cable 95. In an implementation, one end of the flexible flat cable 95 is connected to an outer periphery of the first circuit board 91, and the other end of the flexible flat cable 95 is connected to an inner periphery of the second circuit board 93. In other implementations, the flex 95 may be replaced with a flexible circuit board or wire.

The circuit board assembly 90 is further provided with a frequency divider 96, and the frequency divider 96 is configured for frequency division. Specifically, the frequency divider 96 is configured to filter out a high-frequency part of a bass system and a low-frequency part of a treble system, so that a low-frequency part of the bass system and a high-frequency part of the treble system are combined, and a whole frequency band performance of the hybrid speaker 100 is better. The frequency divider 96 includes a filter capacitor. Specifically, the frequency divider 96 may be a filter capacitor, and the filter capacitor may be welded on the first circuit board 91 or the second circuit board 93. In this implementation, the frequency divider 96 is welded on the first circuit board 91.

In other implementations, the divider 96 may also be a circuit having a filtering function, such as a filter.

In other implementations, a high-frequency filter capacitor and a low-frequency filter capacitor may also be used at the same time to replace a variable capacitor, and the high-frequency filter capacitor is configured to filter the high-frequency part of the bass system and the low-frequency filter capacitor is configured to filter the low-frequency part of the treble system.

As illustrated in FIGS. 2 and 3, the hybrid speaker 100 further includes a rear cover 70, the rear cover 70 fits with the side wall 223, and the rear cover defines a sound-adjusting hole 75. Specifically, the rear cover 70 includes a back plate 71 and an edge plate 73 surrounding the back plate 71. The back plate 71 and the edge plate 73 form a box-like structure. The sound-adjusting hole 75 is defined in the back plate 71. The edge plate 73 is configured to fit with the side wall 223. In an implementation, the edge plate 73 abuts against a periphery of a rear side of the second diaphragm 52.

In an implementation, the first sound hole 2201, the second sound hole 2203, and the sound-adjusting hole 75 each are covered with a sound-adjusting member. The sound-adjusting member is not only configured to adjust volume, but also configured to prevent dust or debris from entering the hybrid speaker 100 through the first sound hole 2201, and/or the second sound hole 2203, and/or the sound-adjusting hole 75. Specifically, the first sound hole 2201 is covered with a first sound-adjusting member 81, the second sound hole 2203 is covered with a second sound-adjusting member 83, and the sound-adjusting hole 75 is covered with a third sound-adjusting member 85. In this implementation, the first sound-adjusting member 81, the second sound-adjusting member 83, and the third sound-adjusting member 85 each are a sound-adjusting net.

Please refer to FIGS. 1-3 and 7-8 together, when the hybrid speaker 100 is assembled, the circuit board assembly 90 is installed to the second shell 20. Specifically, the first circuit board 91 is fixedly attached to the outer side of the top wall 221, and the through hole 912 is aligned with the second sound hole 2203. The second circuit board 93 is fixedly attached to the outer side of the connecting plate 2234. The first shell 30 accommodating the balanced-diaphragm unit-structure 40 is accommodated in the inner cavity of the second shell 20, the wire 432 of the first coil 43 passes through the second sound hole 2203 along the wire groove 2214 and the wire slot 913 to be connected to the first solder pad 915, and the wire 442 of the second coil 44 passes through the second sound hole 2203 along the wire groove 2214 and the wire slot 913 to be connected to the second solder pad 916. One end of the connecting cylinder 31 away from the magnetic conductive plate 33 is fixedly connected to the inner side of the top wall 221, so that an inner cavity of the first coil 43 faces the second sound hole 2203. In this case, the annular second gap 601 is defined between the outer circumferential surface of the first shell 30 and the inner circumferential surface of the first cylinder 2231. The moving-coil unit-structure 50 is installed in the positioning groove 2235 of the second cylinder 2233 via the connecting pad 521. The connecting pad 521 may be fixed to the second shell 20 by means of adhesive, clamping, or the like, so that the second diaphragm 52 is fixedly connected to the second shell 20. One end of the voice coil 54 away from the second diaphragm 52 may be movably inserted into the second gap 601, the magnetic conductive plate 33 of the first shell 30 extends at least to a middle position in an axial direction of the voice coil 54, and a wire connected to the voice coil 54 passes through the wire outlet 2237 and is then connected to the third solder pad 931 of the second circuit board 93. The rear cover 70 covers a rear side of the moving-coil unit-structure 50. Specifically, the edge plate 73 of the rear cover 70 is clamped in the positioning groove 2235 and abuts against the periphery of the second diaphragm 52, so that the rear cover 70 is fixed to the rear side of the second shell 20. Finally, the first sound hole 2201, the second sound hole 2203, and the sound-adjusting hole 75 are each covered with a sound-adjusting member.

In this case, an axis of the second diaphragm 52 is collinear with an axis of the first diaphragm 42, that is, the balanced-diaphragm unit-structure 40 and the moving-coil unit-structure 50 are arranged in an axial direction of the second shell 20. The balanced-diaphragm unit-structure 40 is disposed at a front side of the moving-coil unit-structure 50. The second inner cavity 35 of the first shell 30 communicates with the second sound hole 2203, and sound generated by vibration of the first diaphragm 42 is emitted out of the second sound hole 2203 through the second inner cavity 35. The first inner cavity 201 of the second shell 20 communicates the first sound hole 2201, and sound generated by vibration of the second diaphragm 52 is emitted out of the first sound hole 2201.

When no current flows through the first coil 43 and the second coil 44, the first diaphragm 42 is neutralized, and the first diaphragm 42 is located in the middle of the first gap 422 through balance of an up magnetic field of the first magnet 45 and a down magnetic field of the second magnet 46 and a restoring force of the first diaphragm 42. When an external audio signal is applied to the first circuit board 91, audio current pass through each of the first coil 43 and the second coil 44, the first coil 43 and the second coil 44 each generate a magnetic field which changes with the audio current, and the magnetic field and the magnetic fields of the first magnet 45 and the second magnet 46 generate an interaction force. This force causes the first diaphragm 42 to vibrate along with the audio current in the magnetic fields of the first magnet 45 and the second magnet 46, vibration of the first diaphragm 42 generates sound having the same waveform as an original audio signal. Specifically, when the current on the first coil 43 and the second coil 44 is in a positive period, a direction of the inner magnetic field direction of the first coil 43 and a direction of the inner magnetic field direction of the second coil 44 face each other towards an inner side, the first diaphragm 42 is N-polarized, and therefore the first diaphragm 42 moves towards the front side. When the current on the first coil 43 and the second coil 44 is in a negative period, the direction of the inner magnetic field direction of the first coil 43 and the direction of the inner magnetic field direction of the second coil 44 are opposite to each other towards an outside, the first diaphragm 42 is S-polarized, and therefore the first diaphragm 42 moves towards the rear side. In this way, the first diaphragm 42 may vibrate along with the audio current to generate the sound having the same waveform as the original audio signal, and the sound is output from the second sound hole 2203. In addition, a direction of magnetization may be changed according an arrangement direction of magnetic poles of the first magnet 45 and the second magnet 46.

Because one end of the voice coil 54 away from the second diaphragm 52 is sleeved on the outer periphery of the first shell 30, the voice coil 54 is disposed in the magnetic fields generated by the first magnet 45 and the second magnet 46. When an external audio signal is applied to the second circuit board 93, audio current flows on the voice coil 54, the voice coil 54 generates a magnetic field that changes with the audio current. The magnetic field and a magnetic circuit generated by the first magnet 45 and the second magnet 46 generate an interaction force, and the force causes the voice coil 54 to vibrate up and down with the audio current. The second diaphragm 52 is connected to the voice coil 54, and therefore the voice coil 54 drives the second diaphragm 52 to vibrate, and vibration of the second diaphragm 52 generate sound having the same waveform as the original audio signal. The sound is emitted out of the first sound hole 2201.

In the present disclosure, since the balanced-diaphragm unit-structure 40 and the moving-coil unit-structure 50 share the first magnet 45 and the second magnet 46, the thickness of the moving-coil unit-structure 50 is reduced by at least 2 millimeters, thereby reducing the space occupied by the balanced-diaphragm unit-structure 40 and the moving-coil unit-structure 50 arranged axially, and reducing the volume of the hybrid speaker 100. The first diaphragm 42 has a relatively large radial area, so that a sound pressure of the first diaphragm 42 can be further improved, a high frequency response is greatly widened, and a frequency response is greatly improved in a frequency band from 8 KHz to 40 KHz. Further, the second diaphragm 52 has a radial area larger than the first diaphragm 42, so that the second diaphragm 52 has a greater motion displacement, and thus the moving-coil unit-structure 50 has a powerful and excellent low frequency.

The balanced-diaphragm unit-structure 40 of the hybrid speaker 100 is applicable to a high-frequency part and the moving-coil unit-structure 50 of the hybrid speaker 100 is applicable to a mid-low-frequency part, that is, the balanced-diaphragm unit-structure 40 and the moving-coil unit-structure 50 can focus on respective sound domains independently and emit sound coaxially. The inner diameter of the voice coil 54 is greater than the diameter of the first diaphragm 42, so that the voice coil 54 with a greater inner diameter specializes in delivering an elastic, rich, and full low frequency, and the first diaphragm 42 specializes in high-frequency transient and high resolution, resulting in a naturally wide sound field.

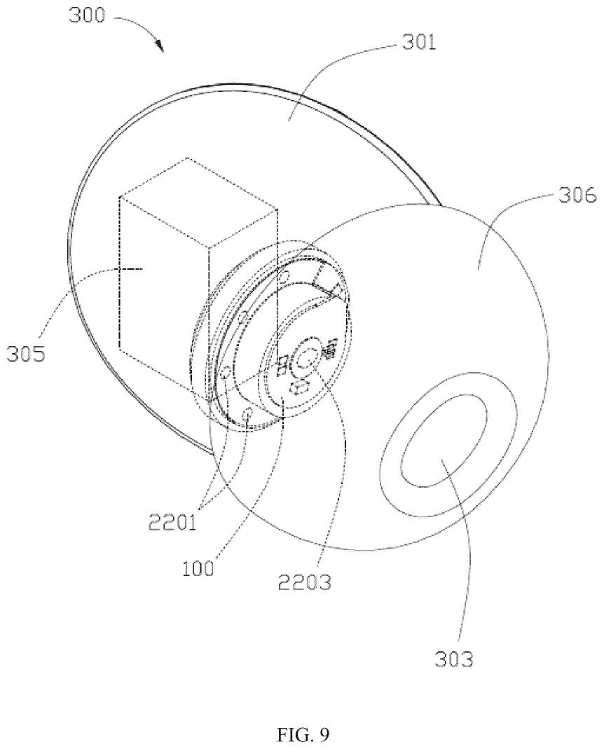

As illustrated in FIG. 9, the present disclosure also provides an audio reproduction device 300. The audio reproduction device 300 includes a housing 301 and a hybrid speaker 100. The housing 301 defines an inner cavity and a sound channel 303 communicating with the inner cavity. The hybrid speaker 100 is disposed in the inner cavity of the housing 301. The first sound hole 2201 and the second sound hole 2203 of the hybrid speaker 100 communicate with the sound channel 303. Sound generated by the hybrid speaker 100 enters the sound channel 303 through the first sound hole 2201 and the second sound hole 2203, and then is output from the sound channel 303.

The audio reproduction device 300 further includes a battery 305 electrically connected to the hybrid speaker 100, and the battery 305 is configured to supply power to the hybrid speaker 100 and other electronic devices. Because the volume of the hybrid speaker 100 is reduced, that is, the space of the inner cavity of the housing 301 occupied by the hybrid speaker 100 is reduced, the volume of the battery 305 can be increased, so as to improve the endurance of the audio reproduction device 300; or when the volume of the battery 305 is not changed, the layout of other electronic devices can be facilitated, or the overall volume of the audio reproduction device 300 can be further reduced.

In this implementation, the audio reproduction device 300 is an earphone, the housing 301 of the earphone is provided with a sound-transmission tube along the sound channel 303, and an ear cap 306 is sleeved on the sound-transmission tube. When the earphone is inserted into the user's ear canal through the cap 306, the balanced-diaphragm unit-structure 40 is closer to the sound channel 303 than the moving-coil unit-structure 50, that is, the first diaphragm 42 of the hybrid speaker 100 is located in front of a mid-low frequency moving-coil diaphragm system, and is closer to the user's ear canal. Therefore, a path through which a sound wave passes is shortened, so that the sound is clearer, and user experience is improved.

In other implementations, the audio reproduction device 300 may also be a loudspeaker box or the like, and the hybrid speaker 100 in the present disclosure may be applied to electronic products that need to emit sound, such as a computer, a television, and a mobile phone.

The foregoing are implementations of the present disclosure. It should be noted that, a person of ordinary skill in the art may further make improvements and modifications without departing from the principle of the implementations of the present disclosure, and these improvements and modifications shall also belong to the scope of protection of the present disclosure.

What is claimed is:

1. A hybrid speaker, comprising:
a low-frequency portion configured to output mid-frequency sound or low-frequency sound, wherein the low-frequency portion comprises a moving-coil unit-structure, and the moving-coil unit-structure comprises a magnetic driving portion; and
a high-frequency portion configured to output high-frequency sound, wherein the high-frequency portion comprises a balanced-diaphragm unit-structure, and the balanced-diaphragm unit-structure is configured as the magnetic driving portion of the moving-coil unit-structure.

2. The hybrid speaker according to claim 1, wherein the balanced-diaphragm unit-structure comprises a first shell, and the first shell is cylindrical; and the moving-coil unit-structure comprises a voice coil, and the voice coil is partially sleeved outside the first shell.

3. The hybrid speaker according to claim 2, wherein the balanced-diaphragm unit-structure further comprises a first coil, a second coil, and a first diaphragm that are disposed in an inner cavity of the first shell, the first coil is coaxial with the second coil, a first gap is defined between the first coil and the second coil, and the first diaphragm is disposed in the first gap.

4. The hybrid speaker according to claim 3, wherein the balanced-diaphragm unit-structure further comprises a first magnet sleeved outside the first coil and a second magnet sleeved outside the second coil, and the first gap is defined between the first magnet and the second magnet.

5. The hybrid speaker according to claim 4, wherein the balanced-diaphragm unit-structure further comprises a first washer and a second washer that are disposed in the first gap, the first washer is disposed between the first diaphragm and the first magnet, and the second washer is disposed between the first diaphragm and the second magnet, and the first washer and the second washer are configured to limit the first diaphragm.

6. The hybrid speaker according to claim 4, wherein the first shell comprises a connecting cylinder sleeved outside the first magnet and the second magnet, and a magnetic conductive plate connected to one end of the connecting cylinder away from the first magnet, the second magnet is stacked on the magnetic conductive plate, the magnetic conductive plate is configured to adjust a magnetic field of the balanced-diaphragm unit-structure, so as to realize a function of the magnetic driving portion in the moving-coil unit-structure.

7. The hybrid speaker according to claim 6, further comprising:
a second shell, wherein the second shell is configured as an outer frame of the moving-coil unit-structure, the first shell is connected to an inner wall of the second shell, the moving-coil unit-structure further comprises a second diaphragm connected to the voice coil, and one end of the voice coil away from the second diaphragm is sleeved around the magnetic conductive plate.

8. The hybrid speaker according to claim 7, wherein the second shell defines a first sound hole, the first sound hole communicates a first inner cavity of the second shell with an external space, and the first sound hole is configured as a sound channel of the low-frequency portion.

9. The hybrid speaker according to claim 8, wherein the second shell defines a second sound hole, the second sound hole communicates a second inner cavity of the first shell with the external space, and the second sound hole is configured as a sound channel of the high-frequency portion.

10. The hybrid speaker according to claim 9, wherein a periphery of the second diaphragm is connected to an opening of the second shell, and the second diaphragm, the first shell, and the second shell cooperative define the first inner cavity.

11. The hybrid speaker according to claim 10, wherein the second shell comprises a top wall and a side wall surrounding a periphery of the top wall, one end of the connecting cylinder away from the magnetic conductive plate is connected to the top wall, the first sound hole is defined in the side wall, and the second sound hole is defined in the top wall.

12. The hybrid speaker according to claim 11, wherein the side wall comprises a first cylinder surrounding an edge of the top wall and a second cylinder disposed at one end of the first cylinder away from the top wall, and a connecting plate connected between the first cylinder and the second cylinder; and wherein the periphery of the second diaphragm is connected to an inner circumferential wall of the second cylinder, and the first sound hole is defined in the connecting plate.

13. The hybrid speaker according to claim 12, wherein an inner diameter of the second cylinder is greater than an inner diameter of the first cylinder.

14. The hybrid speaker according to claim 12, wherein the connecting cylinder is coaxial with the first cylinder, an outer diameter of the connecting cylinder is less than an inner diameter of the first cylinder, a second gap is defined between the connecting cylinder and the first cylinder, and the voice coil is disposed in the second gap.

15. The hybrid speaker according to claim 11, further comprising:
a rear cover, wherein the rear cover fits with the side wall, and the rear cover defines a sound-adjusting hole.

16. The hybrid speaker according to claim 11, further comprising:
a first circuit board, wherein the first circuit board is disposed on an outer side of the top wall, and the first coil and the second coil are electrically connected to the first circuit board respectively.

17. The hybrid speaker according to claim 16, wherein the first circuit board is positioned on the outer side of the top wall, the top wall defines a wire groove on an inner side of the top wall, the first coil and the second coil are connected to the first circuit board through wires, and the wires are accommodated in the wire groove.

18. The hybrid speaker according to claim 16, further comprising:
a second circuit board, wherein the second circuit board is disposed on an outer side of the side wall, and the voice coil is electrically connected to the second circuit board.

19. The hybrid speaker according to claim 11, wherein the second shell defines a wire outlet at a position of a side wall of the second shell away from the top wall, and the wire outlet is configured for insertion of a wire.

20. An audio reproduction device, comprising:
a housing and a hybrid speaker, wherein the hybrid speaker comprises:
a low-frequency portion configured to output mid-frequency sound or low-frequency sound, wherein the low-frequency portion comprises a moving-coil unit-structure, and the moving-coil unit-structure comprises a magnetic driving portion; and
a high-frequency portion configured to output high-frequency sound, wherein the high-frequency portion comprises a balanced-diaphragm unit-structure, and the balanced-diaphragm unit-structure is configured as the magnetic driving portion of the moving-coil unit-structure;
wherein the housing defines an inner cavity and a sound channel communicating with the inner cavity, the hybrid speaker is disposed in the inner cavity, and a first sound hole and a second sound hole of the hybrid speaker communicate with the sound channel.
